(19) United States
(12) Patent Application Publication
(10) Pub. No.: US 2006/0158684 A1
(43) Pub. Date: Jul. 20, 2006

(54) Printing system and method

(75) Inventors: David Partanen, Stoney Creek (CA); Arron Fu, Toronto (CA)

Correspondence Address: FETHERSTONHAUGH - SMART & BIGGAR, 1000 DE LA GAUCHETIERE WEST, SUITE 3300, MONTREAL, QC, H3B 4W5, CA

(73) Assignee: BCE INC.

(21) Appl. No.: 11/313,726

(22) Filed: Dec. 22, 2005

(30) Foreign Application Priority Data
Dec. 31, 2004 (CA) 2,491,385

(51) Int. Cl. G06F 3/12

(52) U.S. Cl. 358/1.15

(57) ABSTRACT

The present invention provides a system and method for printing. In a system embodiment, a printer server interconnects a plurality of clients and printers. The server maintains a printer access policy that defines which of said printers a user can access. When a user logs into one of the clients, the server accesses said printer access policy and forwards a list of printers that the user can access to the client.

### FIELD OF THE INVENTION

The present invention relates generally to sharing of computer peripherals and more particularly to a printing system and method.

### BACKGROUND

Computer networking is well known as a way to share computing resources. The sharing of computer peripherals, such as printers, is a great benefit of computer networks. Without a computer network, users need to have a printer local to their computing device in order to print their work. Multiple computers that share a single printer reduce cost of the network by reducing the number of necessary printers and centralizing the maintenance of printers in the network.

Shared printers also mean that expensive, highly complex, specialized printers can be made available to multiple users on a cost effective basis. For example, colour printers and plotters are two examples of specialized printers that are more cost effectively utilized when shared over a network.

However, in large networks, network administration of shared printers can in and of itself become a problem. For example, when trying to connect a computing device to a network printer, a user can be faced with dozens of choices of printers, each having baffling names. In fact, such users are typically only interested in a few of the available choices—typically choices that reflect printers within a reasonably geographic distance of the computing device.

In many standard distributed computing systems involving a network of full function personal computers, users are able to customize printer list views at each personal computer they are logged into. The user can, for instance, generate a list of available printers at each personal computer she logs into. The list is locally saved on the personal computer and presented to the user the next time she logs in at the same personal computer. The settings, however, are kept locally on the personal computer and thus the user of each client needs to still go through an initial exercise of culling the list of available printers from a broader list.

U.S. 2004/0196486 to Uchino discloses an address book service for network printers that also attempts to address some of these problems. Uchino aims to solve a problem associated with identifying remote network printers within systems that provide printing capabilities over a local area network (“LAN”), wide area network (“WAN”) or the Internet. When printers are registered in the address book system, information regarding printing device name, location, internet protocol (“IP”) address and other parameters are provided (Page 1, Para. 0005). When a user needs to send a print job to one of the network printers, she may select any or all of the printing devices on the printer list provided by the network server (Page 5. Para 0048). Printer lists show all printers that the user is authorized to use, along with an address for each printing device location, its model name, IP Address, activity status and the like (ex. item 44 on FIG. 2). While Uchino does help the user to choose a desired one of many available printers, this assistance is provided by providing a detailed description about each printer, but still leaves the user with a large list of printers from which to choose.

### SUMMARY OF THE INVENTION

It is an object of the present invention to provide a novel printing system and method that obviates or mitigates at least one of the above-identified disadvantages of the prior art.

An aspect the invention provides networked computing apparatus comprising an interface coupled to a plurality of clients via at least one link. Each of the clients is operable to transmit a print request to a plurality of printers. The apparatus further includes a data storage device for storing a data file comprising a record comprising at least one default printer identification respective to an indicia obtainable from one of said clients; each of the at least one default printer identifications being chosen to identify one of the printers. The apparatus further includes a processing unit coupled to the interface and the data storage device, the processing unit adapted for receiving the indicia from one of the clients and being operable to retrieve the record using the received indicia. The processing unit is further operable to forward the at least one default printer identification to the one of the clients from which the indicia was received. The indicia can include a client identifier associated with the one of the clients, and the least one default printer identification can include at least one default printer identification corresponding to at least one printer physically proximate to the one of the clients.

The client identifier can include, for example, a network address assigned to one of the clients and a machine identifier associated with the assigned client.

One or more of the at least one default printer identifications can correspond to printers which a given user is permitted to access, based upon access rights of the user. The user identifier can include, for example, a group identifier associated with a group of which the user is a member. In such embodiments the at least one default printer identification can include at least one default printer identification corresponding to at least one printer associated with the group of which the user is a member. Groups can consist of user members grouped, for example, by job title, job function, job level, organization, department, customer type, predefined physical location and customer account balance.

Another aspect of the invention provides an application server apparatus incorporating networked computing apparatus as disclosed herein, the application server apparatus operable to host at least one application for the one of said clients. In order to forward a default printer identification to the one of said clients, a processing unit is operable to forward thee default printer identification to the application in a printer setting change message comprising said at least one default printer identification. The application is operable to forward the at least one default printer identification to the clients in a print request response message in response to a print job request from the client, the print request response message comprising a printer selection option including the default printer identification. The application can further be operable to receive a print request confirmation message comprising a selection of a printer in response to a printer selection option; and to generate a print job corresponding to a print job request and transmit the generated print job to the selected printer.

Another aspect of the invention provides an application server apparatus incorporating networked computing apparatus as disclosed herein, the application server apparatus being operable to host at least one application for a client and including a processing unit operable to receive a request for a print job corresponding to the application from the client; wherein the processing unit is operable to forward a default printer identification to the client in a print request response message comprising a printer selection option including the default printer identification.

Another aspect of the invention provides methods for processing data for use in printing computer output. The methods include receiving indicia from clients, each of the clients operable to transmit print requests to pluralities of printers; retrieving data records comprising default printer identifications respective to the received indicia; each default printer identification chosen to identify one of said printers; and forwarding the default printer identifications to the clients from which the indicia were received. The indicia can include, for example, client identifiers associated with the clients, and/or with users of the clients. Users can be identified as belonging to groups, based for example on job title, job function, job level, organization, department, customer type, predefined physical location and customer account balance.

Default printer identifications can include, for example, identifications of printers associated with the users, based upon access rights associated with the users or user groups.

Such methods may also include, for example, input from users of clients, the input changing default printer identifications; and forwarding default printer identifications to clients in a print request response messages comprising printer selection options which include default printer identifications.

In another aspect the invention provides servers for use in apparatus according the invention in, for example, distributed computing environments in which processing and/or storage of data is shared by one or more computing devices, including for example processors associated with clients. Such servers can for example be used in identifying default printer identifications chosen according to which one of a plurality of clients a given user is accessing. This can include, for example, default printer identifications chosen based on which of said printers is closest to the one of the clients from which an identity was received, access rights that exclusively indicate which of said at least one printers each said user is permitted to access, and/or indicators associated with each of the printers. Indicators associated with each of the printers can include, for example, identities of each of the clients and an association based on which one of the printers is geographically closest to each of said clients, and/or a type of each of the printers.

Other aspects of the invention provide computer readable media useful in implementing the invention, including for example executable computer programming suitable for causing apparatus according to the invention to execute the methods and processes described herein.

### BRIEF DESCRIPTION OF THE DRAWINGS

The invention will now be described by way of example only, and with reference to certain embodiments and the accompanying drawings, in which:

FIG. 1 is a schematic representation of a printing system in accordance with an embodiment of the invention;

FIG. 2 is a flowchart depicting a method of printing in accordance with another embodiment of the invention;

FIG. 3 shows the system of FIG. 1 during an exemplary performance of the method of FIG. 2;

FIG. 4 shows the system of FIG. 1 during an exemplary performance of the method of FIG. 2;

FIG. 5 shows the system of FIG. 1 during an exemplary performance of the method of FIG. 2;

FIG. 6 shows the system of FIG. 1 during an exemplary performance of the method of FIG. 2;

FIG. 7 shows a user interface in accordance with another embodiment of the invention; and

FIG. 8 is a flowchart depicting a method of printing in accordance with another embodiment of the invention.

### DETAILED DESCRIPTION OF EMBODIMENTS

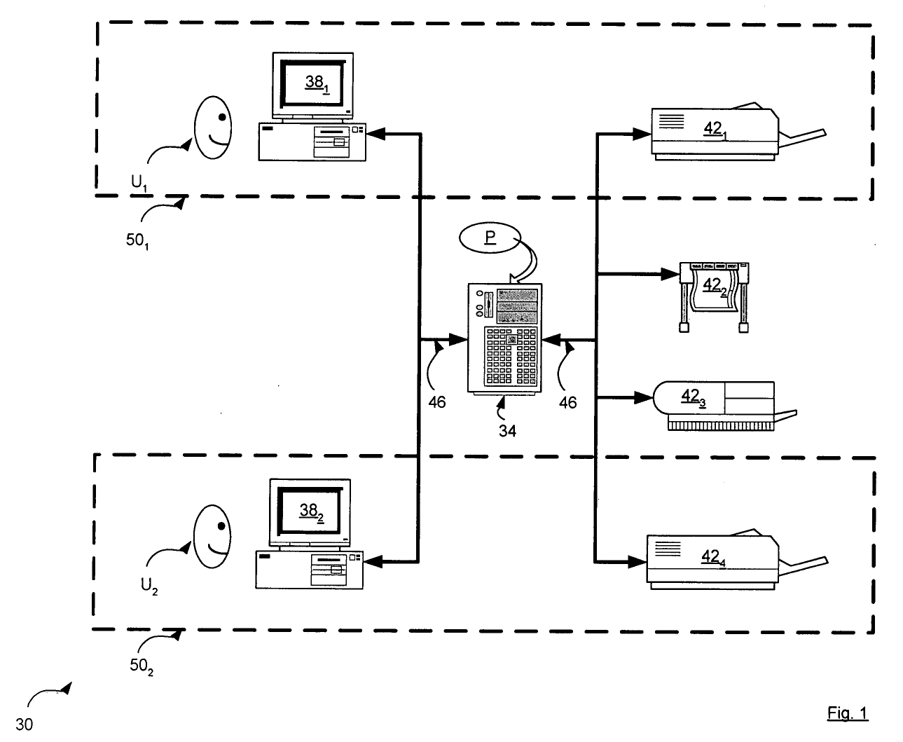

Referring now to FIGS. 1, a printing system in accordance with an embodiment of the invention is indicated generally at 30. System 30 comprises a server 34 that serves, at least, the administration of print jobs from a plurality of clients 38₁ and 38₂, which are collectively referred to as clients 38, and generically as client 38. While in a present embodiment server 34 is primarily a printer server, server 34 can include other functionalities such as a file server, and/or an application server to host execution of applications for clients 38. Alternatively, system 30 can be modified to include separate computing devices to function as a file server, application server and the like, leaving server 34 dedicated to functioning as a printer server.

Clients 38 are any general computing device operable to receive user input and present user output. Clients 38 are also interoperable with server 34, in that they are at least operable to instruct server 34 to print jobs on behalf of those clients 38. Clients 38 can be, for example, personal computers, thin-client computers, laptop computers, personal digital assistants, cellular telephones, email devices such as those devices sold under the trademark “Blackberry” from Research In Motion of Waterloo, Canada. Clients 38 can thus be functional as standalone computers that execute applications and generate print jobs from those applications, or, clients 38 can simply be ‘dumb terminals’ that rely on a central server (where such functionality is incorporated into server 34) to actually execute applications on behalf of those dumb terminals.

System 30 also includes a plurality of printers 42₁, 42₂, 42₃ and 42₄, which are collectively referred to as printers 42, and generically as printer 42. Printer 42₁ is a black-and-white laser printer; printer 42₂ is a colour plotter; printer 42₃ is a colour laser printer; and printer 42₄ is another black-and-white laser printer. As will be explained in greater detail below, printers 42₁ and 42₄ are also collectively referred to herein as local printers, while printers 42₂ and 42₃ are also collectively referred to as special printers. Printers 42 are all under the direction of server 34, and, in general terms, server 34 is operable to maintain a policy for selectively routing print jobs originating at any one client 38 to an appropriate printer 42, and the details of such routing selection will be explained in greater detail below. Alternatively, server 34 could be divided into a server or database that stores the policy and a server that functions as the printer server.

Server 34, clients 38 and printers 42 are all interconnected by at least one network link 46. Link 46 can be based on any wired or wireless technology, or hybrids thereof. For example, link 46 can be a direct cable connection such as Universal Serial Bus (“USB”), a LAN, a WAN, a T1, a T3, a OC1, and based on any desired protocols such as the Internet, Ethernet, 802.11 and its variants, Bluetooth and its variants, and/or hybrids of any of the foregoing. In general, the structure of link 46 is not particularly limited and in some embodiments the link between server 34 and each of clients 38 are different than the link between server 34 and each of printers 42. Further, in some embodiments, one or more of printers 42 are connected directly to at least one of the clients 38. In this case, server 34 could be coupled to the printer 42 via one of the clients 38 and can pass print jobs to the printer 42 through the particular client 38. Thusly, server 34, clients 38 and printers 42 all include the appropriate network interfaces in order to communicate with each other via link 46. It should now be understood that the layout of system 30 in FIG. 1 is presented in a simplified manner so as to assist in explanation of the embodiments herein.

Server 34 thus typically includes a data storage device (or other persistent storage), a processing unit connected to the storage device for receiving information stored thereon, random access memory (or other volatile storage) connected to the processing unit, and at least one network interface connected to the processing unit and for connecting server 34 to other elements in system 30 via link 46.

Also shown in FIG. 1 are two users indicated at U₁ and U₂. Users U each have accounts that allow them to access server 34 via either of clients 38. When such access is gained, users U can print documents to selected ones of printers 42 according to a policy established at server 34.

FIG. 1 also shows two geographic areas, indicated at 50₁, and 50₂. Areas 50 represent spaces in an office or other work environment wherein a particular printer 42 is within a distance convenient for a user U to access that printer 42 in relation to a client 38 located within the same area. More specifically, area 50₁ includes client 38₁ and local printer 42₁, while area 50₂ includes client 38₂ and local printer 42₄. Thus, a user U using client 38₁ wishing to print out a black and white laser printed document would prefer to use local printer hu 42₁ over printer 42₄, but a user U using client 38₂ wishing to print out a black and white laser printed document would prefer to use printer 42₄, over printer 42₁. Data records indicating such preferences can be incorporated into server 34 in a variety of manners. For example, typically each client 38 and each printer 42 in system 30 would have some sort of unique identifier (e.g. a name or an address, such as an internet protocol (“IP”) address) that distinguishes each client 38 and each printer 42 in system 30, and allows communications thereto to be identified by such an identifier. Thus, a system administrator operating server 34 could prepare a table, such as Table I that makes the associations between various clients 38 and their most convenient printers 42 according to the geographic regions.

TABLE I
Most convenient local printers to clients

| | | Column 3 |
|---|---|---|
| Column 1 | Column 2 | Most convenient |
| Entry | Client Identity | printer |
| 1 | 38₁ | 42₁ |
| 2 | 38₂ | 42₂ |

Thus, Table I can be stored in server 34, being created by an administrator of server 34 or one or more administrators/users of clients 38, to manually indicate which printers 42 are most conveniently accessible to respective clients 38, for instance those printers 42 that are physically proximate to the clients 38. It should be understood that the cells in Table I are populated with the reference characters used to identify specific clients 38 and printers 42 in system 30 in the Figures attached hereto, but that in a practical implementation, the cells in Table I would be populated with the unique identifier (e.g. IP address, machine name) used to identify that device in system 30.

In contrast, printer 42₂ and printer 42₃ are not within convenient access to either area 50, (but a user U can reach them to retrieve a print job outputted thereat). In contrast to the simple black and white functionality of local printers 42₁ and 42₂, printer 42₂ and printer 42₃ instead perform more specialized functions corresponding to special types of print jobs that are used by certain types of users. (Recall colour printer 42₃ produces colour laser copies, while plotter printer 42₂ produces plots of technical drawings and the like.)

As an example, assume user U₁ is a graphic designer and therefore user U₁ needs access to colour laser printer 42₃ and by the same token user U₂ is an engineer who needs access to plotter printer 42₂. Continuing with this example, server 34 is operable to store a printer access policy, (represented as an oval at reference P in FIG. 1), that indicates which printers a particular user U is permitted to access. As described above, access policy P could also be stored in another server or database accessible to server 34. Table II shows an exemplary printer access policy P.

TABLE II
Printer Access Policy P

| | Column 2 | Column 3 | Column 4 | Column 5 |
|---|---|---|---|---|
| Column 1 | User | User Job | Local Printer | Special Printer |
| Entry | Identity | Title | Access | Access |
| 1 | U₁ | Graphic | Grant Access to | Grant Access to |
| | | Designer | most convenient | colour laser |
| | | | black and white | printer 42₃ |
| | | | laser printer | |
| 2 | U₂ | Engineer | Grant Access to | Grant Access to |
| | | | most convenient | plotter printer |
| | | | black and white | 42₂ |
| | | | laser printer | |

To explain the structure of Table II further, Column 1 of Table II shows a particular entry in the printer access policy P. Column 2 provides the user identity of particular user U that is subject to the policy. Column 3 provides the job description of the user U identified in the corresponding entry Column 2. Column 4 provides the policy for whether the U identified in the corresponding entry Column 2 is permitted to access a local printer—in other words, a printer that is conveniently proximate to the client 38 at which the user U is logged in. Column 5 provides the policy for whether the user U identified in the corresponding entry Column 2 is permitted to access any of the specialized printers—in other words, whether the user U is permitted to access one of plotter printer 422 or colour laser printer 423.

Examining the contents of Table II shows that, under Column 4 of Entry 1, User U₁ is permitted to access any black and white laser printer that is conveniently located to which user U₁ is logged in. In other words, if user U₁ is logged into client 38₁, then user U₁ is permitted to send black and white print jobs to printer 42₁. By the same token, if user U₁ is logged into client 38₂, then user U₁ is permitted to send black and white print jobs to printer 42₄. It should now be apparent that column 4 of Table II is a “soft” entry, populated dynamically by looking up the information stored in Table I according to which client 38 is being accessed.

Examining the contents under Column 5 of Entry 1, user U₁ is permitted to send jobs to colour laser printer 42₃ regardless of which client 38 is being accessed by user U₁.

(As part of creating policy P, any printer 42 that user U₁ is not expressly granted access rights may also be a printer 42 that user U₁ is not permitted to access. However, as will be discussed in greater detail below, this is merely an option, according to whether policy P is to be used to enforce a security protocol for users of printers 42 in system 30, or whether policy P is simply to establish a default set of available printers 42 when a particular client is accessed.)

Further examining the contents of Table II shows that, under Column 4 of Entry 2, User U₂ is permitted to access any black and white laser printer that is conveniently located to which user U₂ is logged in. In other words, if user U₂ is logged into client 381, then user U₂ is permitted to send black and white print jobs to printer 42₁. By the same token, if user U₂ is logged into client 38₂, then user U₂ is permitted to send black and white print jobs to printer 42₄. Examining the contents under Column 5 of Entry 2, user U₂ is permitted to send jobs to plotter printer 42₂ regardless of which client 38 is being accessed by user U₂.

(Again, as part of creating policy P, any printer 42 that user U₂ is not expressly granted access rights may also be a printer 42 that user U₂ is not permitted to access. And again, as will be discussed in greater detail below, this is merely an option, according to whether policy P is to be used to enforce a security protocol for users of printers 42 in system 30, or whether policy P is simply to establish a default set of available printers 42 when a particular client is accessed.)

While not necessary, in the present example of Table II, the contents of Column 5 can be automatically populated based on the Job Title entered under Column 3. In other words, all users U who are graphic designers will be granted access to colour laser printer 42₃ regardless of which client that user U is logged into; and, all users U who are engineers will be granted access to plotter printer 42₂ regardless of which client that user U is logged into. Thus, it should be understood that Table II (or a table based thereon) need not be manually populated in order to express the printer access policy P, but can be based on more sophisticated criteria to automatically populate all or portions of Table II to express the printer access policy P. Alternatively, Column 5 can be populated specifically for specific users U instead of or in combination with being populated based upon a group that users U belong. Further, it should be understood that other groups other than job title could be utilized. For instance, the group could comprise a plurality of individuals grouped by job function, job level, organization, department, customer type, predefined physical location and customer account balance (i.e. a group based upon customers that have sufficient credit to utilize a specific set of one or more printers).

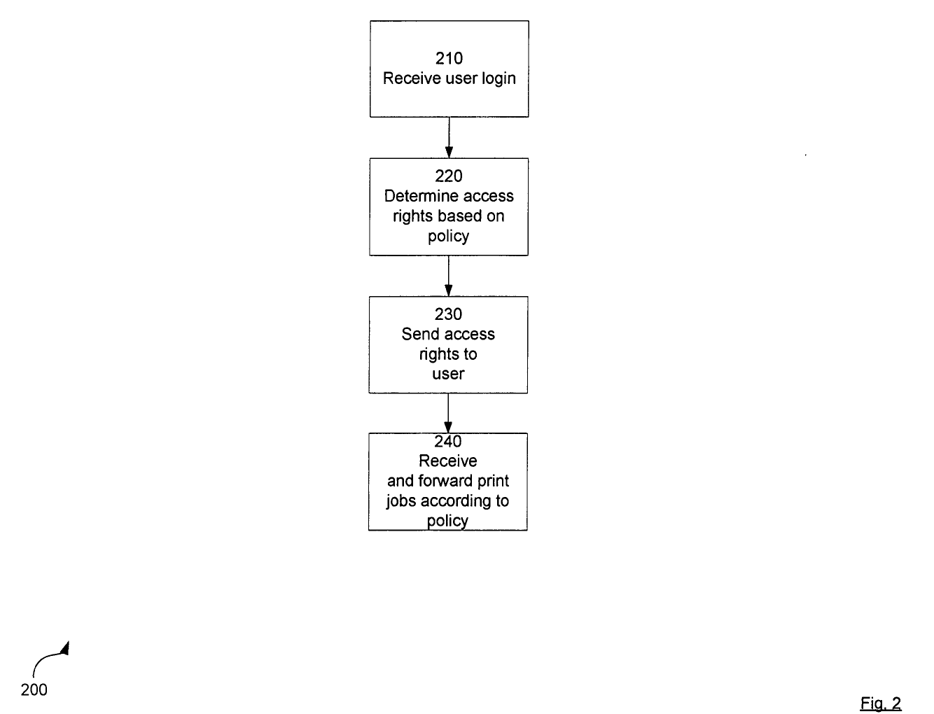

FIG. 2 shows a flowchart representing a printing method indicated generally at 200. For purposes of assisting in the explanation of method 200, it will be assumed that method 200 in FIG. 2 is performed on system 30. However, it is to be understood that apparatus 50 and/or method 200 can be varied, and need not work exactly as discussed herein in conjunction with each other, and that such variations are within the scope of the present invention.

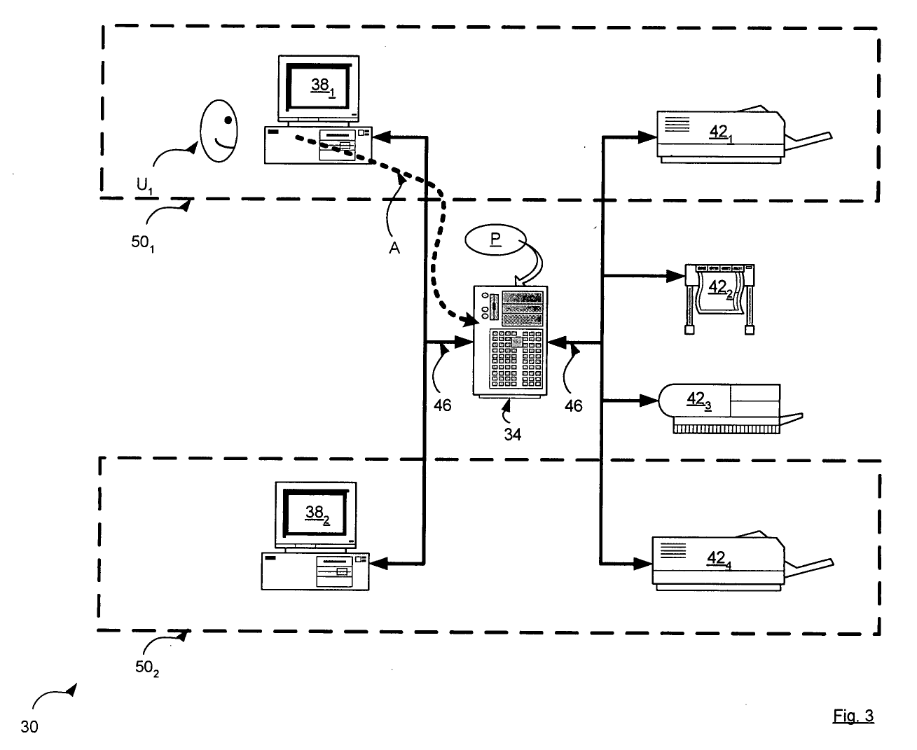

Beginning first at step 210, a user login is received. This step occurs when a user U logs into one of clients 38, in the usual manner, and that login information is forwarded to server 34. A representation of the performance of this step is indicated by the dotted line indicated at reference A in FIG. 3, depicting user U₁ logging into client 38₁, which forwards the login information to server 34. Alternatively, the login information is forwarded to server 34 only upon the user U triggering a request for a print job and server 34 receiving this request.

Next, at step 220, a determination is made as to the access rights for that user login based on the printer access policy. In system 30, this step is performed by server 34 which accesses policy P and determines which printers 42 that user U₁ is permitted to access. Server 34 thus accesses Entry 1 of Table II to make this determination. Server 34 accesses Entry 1 of Table II and determines that, per Column 4, user U₁ is permitted to access a local laser printer, i.e. printer 42₁ and, per Column 5, user U₁ is permitted to access colour laser printer 42₃.

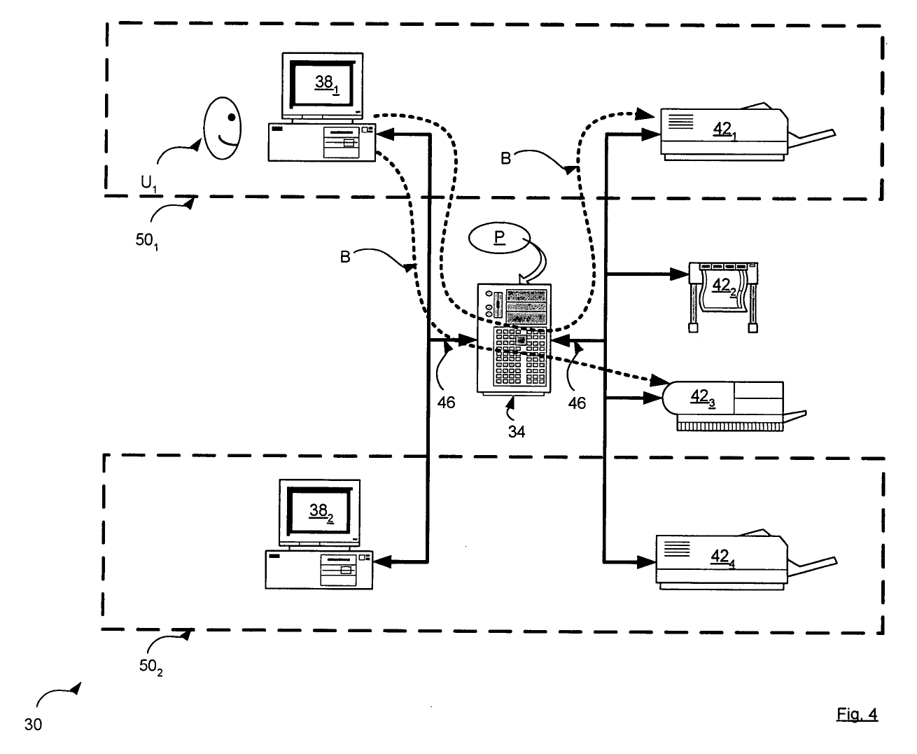

Next, at step 230, the access rights determined at step 220 are sent to the user. In system 30, server 34 forwards the access rights determined at step 220 to client 38₁, and client 38₁ thus is able to access the appropriate printers 42 accordingly. This communication between server 34 and client 38₁ can be in the form of a printer setting change message which includes a request to change the printer settings within the client 38₁ to the printers 42 that the particular user U on client 38₁ is permitted to access. A representation of the performance of this step is indicated by the dotted lines indicated at reference B in FIG. 4, depicting a virtual pathway between client 38₁ and printers 42₁ and 42₃. The absence of any lines between client 38₁ and printers 42₂ and 42₄ represents that access to these printers 42₂ and 42₄ is not permitted. Thusly, policy P has now been implemented for user U₁ when user U₁ is logged into client 38₁.

At step 240, print jobs that are generated are received and forwarded according to the printer access policy. Continuing with the present example, while user U₁ is logged into client 38₁, user U₁ will be able to send print jobs to printers 42₁ and 42₃ along the pathways indicated by dotted lines B in FIG. 4, but will not be able to send print jobs to the remaining printers 42. It should be understood that, although depicted with virtual pathways passing through server 34, in some embodiments, after receiving the access rights determined at step 220, the client 38₁ could send print jobs to the printers 42₁ and 42₃ directly or through another print server that can access printers 42₁ and 42₃.

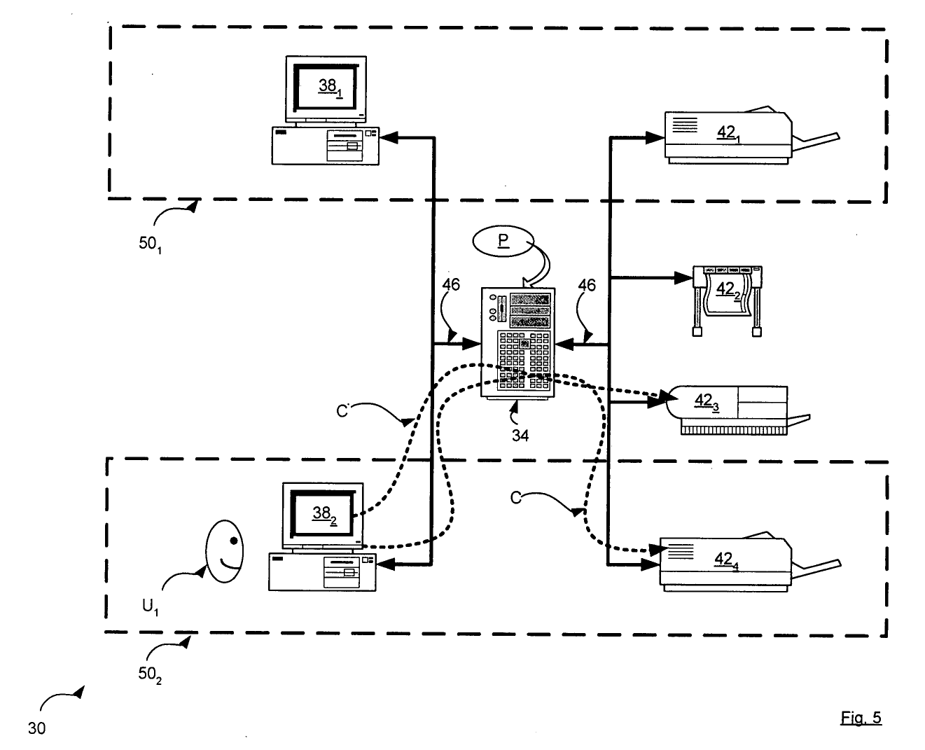

It should now be understood that, if user U₁ logs out of client 38₁ and logs into client 38₂, then upon performance of method 200 user U₁ will be able to send print jobs to printers 42₄ and 42₃. A representation of this example is indicated by the dotted lines indicated at reference C in FIG. 5, depicting a virtual pathway between client 38₂ and printers 42₄ and 42₃. The absence of any lines between client 38₂ and printers 42₁ and 42₂ represents that access to these printers 42₁ and 42₂ is not permitted. Thusly, policy P has now been implemented for user U₁ when user U₁ is logged into client 38₂.

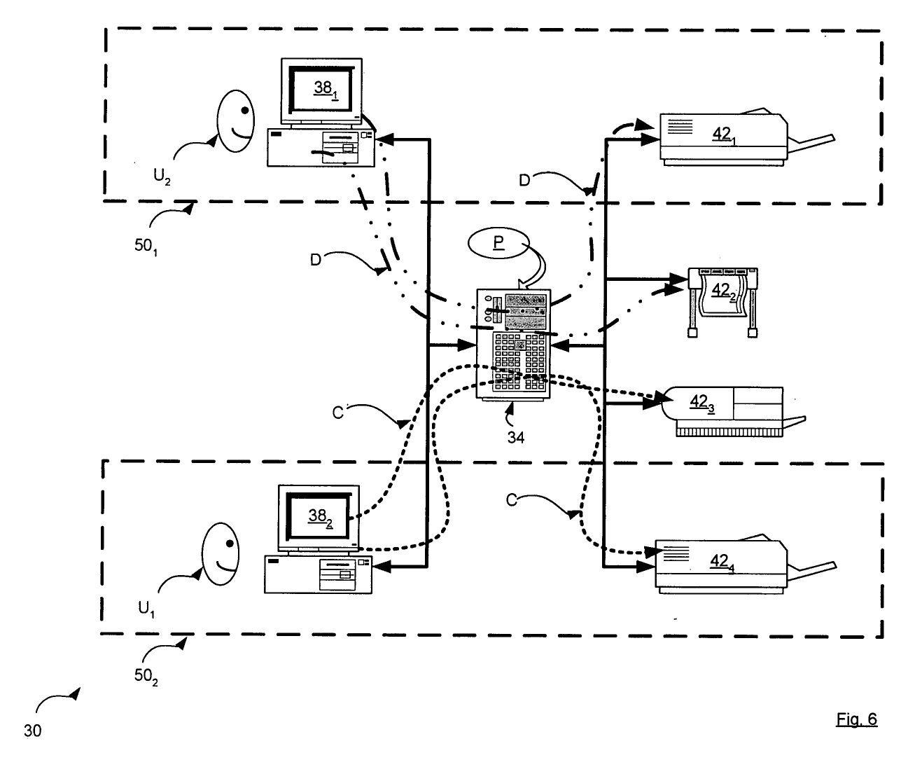

By the same token, assume next that if user U₂ logs into client 38₁, then upon performance of method 200, user U₂ will be able to send print jobs to printers 42₁ and 42₂. A representation of this assumption is indicated by the dotted lines indicated at reference D in FIG. 6, depicting a virtual pathway between client 38₁ and printers 42₁ and 42₂. The absence of any lines between client 38₁ and printers 42₃ and 42₄ represents that access to these printers 42₃ and 42₄ from client 38₁ by user U₂ is not permitted. Thusly, policy P has now been implemented for user U₁ when user U₁ is logged into client 38₂, and when user U₂ is logged into client 38₁.

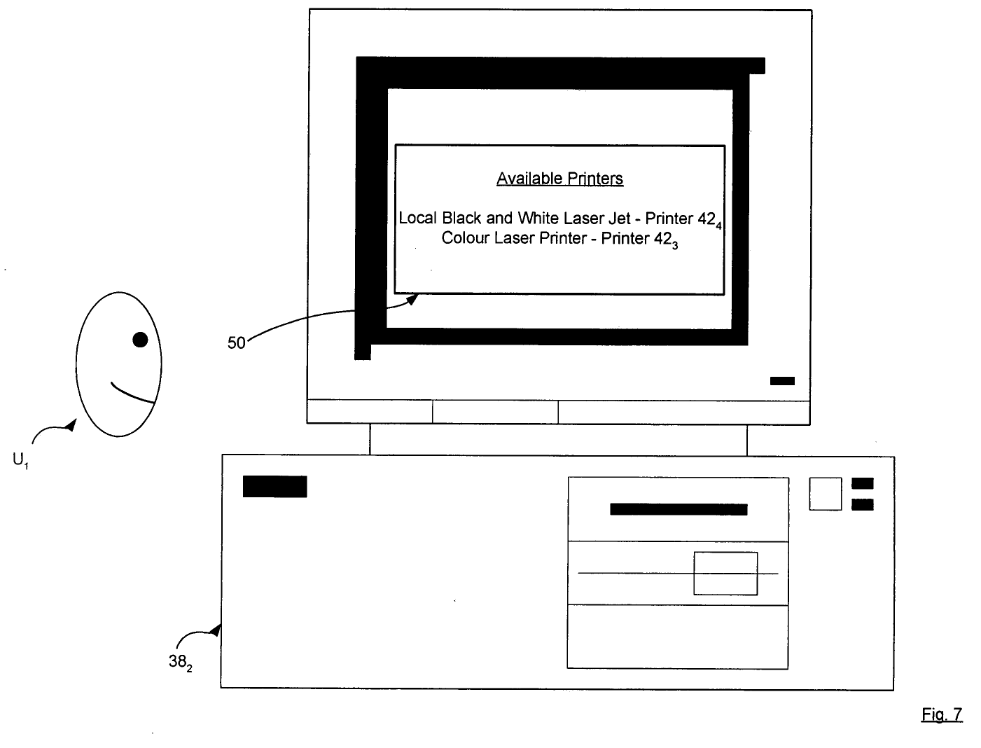

Referring now to FIG. 7, a graphical user interface in accordance with another embodiment of the invention is indicated at 50. Interface 50 is presented on the display of a client 38, and in the particular example in FIG. 7, interface 50 is presented on the display of client 38₂. The information included in the specific example of interface 50 corresponds with the example in FIGS. 5 and 6. Interface 50 includes a list of printers 42 that are available for user U₁ when user U₁ is logged into client 38₂. More specifically, interface 50 in FIG. 7 states:

### Available Printers

### Local Black and White Laser Jet—Printer 42₄

### Colour Laser Printer—Printer 42₃

The information presented in interface 50 is automatically generated as part of the performance of step 230 in method 200. The underlying programming behind interface 50 reflects any known dialogue box that is associated with a particular operating system suitable for client 38₂ and which shows a list of available printers for a user U of that client 38. For example, assuming client 38₂ was executing the operating system sold under the trade-mark “Windows 2000” from Microsoft Corporation of Redmond, Wash., USA then interface 50 would be substantially the same as the dialogue box that is brought up when a user brings up the “Printers” dialogue box available under the “Control Panel” application embedded in Windows 2000. Such a dialogue box can be brought up using various sequences of keys or mouse clicks, such as by clicking the “Start” button from the Windows desktop, followed by the “Settings” item, followed by the “Control Panel” application, and then followed by the “Printers” application. When user U₁ follows such a sequence of mouse clicks after logging into client 38₂, then subsequent to the performance of method 200, the Printers application dialogue box will automatically reflect the information displayed in interface 50 due to the printer setting change message transmitted from the server 34, with no effort required for user U₁ to manually populate interface 50 as occurs now in the prior art. Thusly, when user U₁ is using another application on client 38₂, the printers listed in interface 50 will always be available from that application for use by user U₁. The above also applies in the embodiments that the server 34 is hosting the application being executed by the client 38₂, though the application (e.g. under or within a “Windows 2000” environment) along with the printer settings for the application would reside on the server 34. Further, the printer setting change message would be transmitted to the operating system application within the server 34 and not directly to the client 38₂. The application would then notify the client of the accessible printers upon any print request by the user of the client 38₂ or if the user viewed the printer settings as described above for the “Windows 2000” example.

Alternatively, as described above, in some embodiments, the printer settings are only modified upon a request for a print job from the client 38. In further embodiments, the access policy is accessed each and every time the user U requests a print job. In this case, upon receipt of a request for a print job at server 34, server 34 determines the printers 42 that user U on client 38 may access and forwards a print request response message to the client 38. The print request response message includes a printer selection option that provides the selection of accessible printers. This printer selection option can be displayed to the user U similar to the described display with reference to FIG. 7. Subsequently, upon the user U confirming the request for the print job and completing the selection of a printer from the printer selection option, the server 34 receives a print request confirmation message. In this embodiment, the server 34 can then generate a print job based upon the print job request and forward the print job to the selected printer 42. The above also applies in the embodiments that the server 34 is hosting the application being executed by the client 38, though the application (e.g. “Windows 2000”) would reside on the server 34.

While the foregoing embodiments refer to printer access rights and permissions, in a varied and presently preferred embodiment, policy P is simply a non-exhaustive list of default (or preferred or otherwise desirable) printers 42 from which a particular user U may wish to access. In this varied embodiment, Table II will not be an exclusive list of printers that are accessible for each user U, but will simply be a list of default printers for each user U that are made available to that user U via an interface such as interface 50. Put in other words, each user U will thus be able to access all printers 42 in system 30, but, at least initially, each user U will be shown an interface (such as interface 50) upon the performance of steps 210- 230 of method 200, whereby such an interface will only offer those printers 42 of interest to a particular user U. Advantageously, each user U will thus be presented with a reduced selection of printers 42 from all of the printers 42 available in system 30, but will still have the option to access all printers in system 30. The access of all printers can be achieved in any desired manner, such as by adding other printers to the default list of printers through the use of known interfaces, such as the “Add Printer Wizard”, found under the Windows 2000 Operating System.

Also in this varied embodiment, each user U will have the option of accessing server 34 to update policy P in server 34 from any client 38 or other connection to server 34, so that the user U can self-configure the type of interface, such as interface 50, that will be seen by that user U as that user U accesses different clients 38 in system 30.

As an example of how this can be implemented, steps 210-230 of method 200 can be performed initially for a particular user U (e.g. user U₁) logging into a particular client 38 (e.g. client 38₂). User U₁ would thus be presented with the interface 50 in FIG. 7 as previously described. Next, however, assume that user U₁ adds additional printers available in system 30 using the “Add Printer Wizard” from Windows 2000 (or the like) and/or deletes one or more printers from the default list. Policy P in server 34 can then be updated with such additions and/or subtractions—with a note that such additions and/or subtractions are specific to user U₁ accessing client 38₂. Thus, when user U₁ returns to client 38₂, the default list shown in interface 50 will be shown, plus, the previously effected changes. However, no changes to policy P would be effected for user U₁ accessing a client 38₁; nor would any changes to policy P be effected for user U₂ accessing either client 38, or client 38₂. Changes to policy P with respect to user U₁ accessing a client 38₁; or respecting user U₂ accessing either client 38₁ or client 38₂ could likewise be effected independently.

While only specific combinations of the various features and components of the present invention have been discussed herein, it will be apparent to those of skill in the art that desired subsets of the disclosed features and components and/or alternative combinations of these features and components can be utilized, as desired. For example, modifications to policy P can be effected, and/or additional printers 42, and/or additional users U, and/or additional clients 38 can be added to system 30 and thereby simplify the experience for each user U, while enforcing an access policy, or simply providing a default list of printers, as those users U access a particular client 38. Accordingly, the user U will be presented with a simplified set of choices of printers to access. The experience for user U is made easier, with an interface such as interface 50 being automatically populated for that user U each time the user U logs into a client 38, with a list of usable or otherwise desired printers 42 readily available for that user U. It should now be apparent that such an experience for the user U is particularly desirable in an organization with hundreds of printers, thereby simplifying the task of selecting which printers should be accessible (or immediately available) from a given client 38 within a particular organization.

As an additional example, policy P can include some combination of access rights and/or simple list of default printers. Thus, a user U may be allowed to add certain ones of all types of printers in system 30 to that user U's default list, but not be allowed to add others printers in system 30.

It should now also be understood that the policy P can be based on complex criteria. For example, the criteria used to populate Table II can be combined, so that geographic proximity and job-function are combined to populate the list of printers accessible to a user U. For example, assume that system 30 includes a plurality of printer plotters such as printer plotter 42₂. Now assume a first printer plotter (ie. similar to printer plotter 42₂) is located in area 50, and a second printer plotter (ie. also similar to printer plotter 42₂) is located in area 50₂. Under this configuration, when user U₂ (the engineer) accesses client 38₁ then User U₂ will be given access to the printer plotter located in area 50₁. However, when user U₂ (the engineer) accesses client 38₂ then user U₂ will be given access to the printer plotter located in area 50₂. In this situation, user U₂ can also be given the opportunity to add one or more of all the printer plotters to that user's U₂ default list respective to whichever client 38 that user U₂ is accessing. Such addition can be effected by, for example the “Add Printer Wizard” in Windows 2000 assuming Windows 2000 is executing on that client. Similarly, the user U₂ can be permitted to remove those printer plotters or any other printers on the default list as well.

By the same token, it should be understood that policy P can be based on less complex critiera. For example, policy P can simply be a fixed list of printers 42 that are associated with each user U, regardless of which client 38 is being accessed by that user U. For example, policy P can simply state that user U₁ has access to printer 42₃, and user U₂ has access to printer 42₂. In this specific example, columns 3 and 4 are effectively eliminated from policy P. In another embodiment, policy P can simply be a fixed list of printers 42 that are associated with each client 38, regardless of which user U is logged into the client. For example, policy P can simply state that all users logged into client 38₁ have access to printer 42₁ and all users logged into client 38₂ have access to printer 42₄.

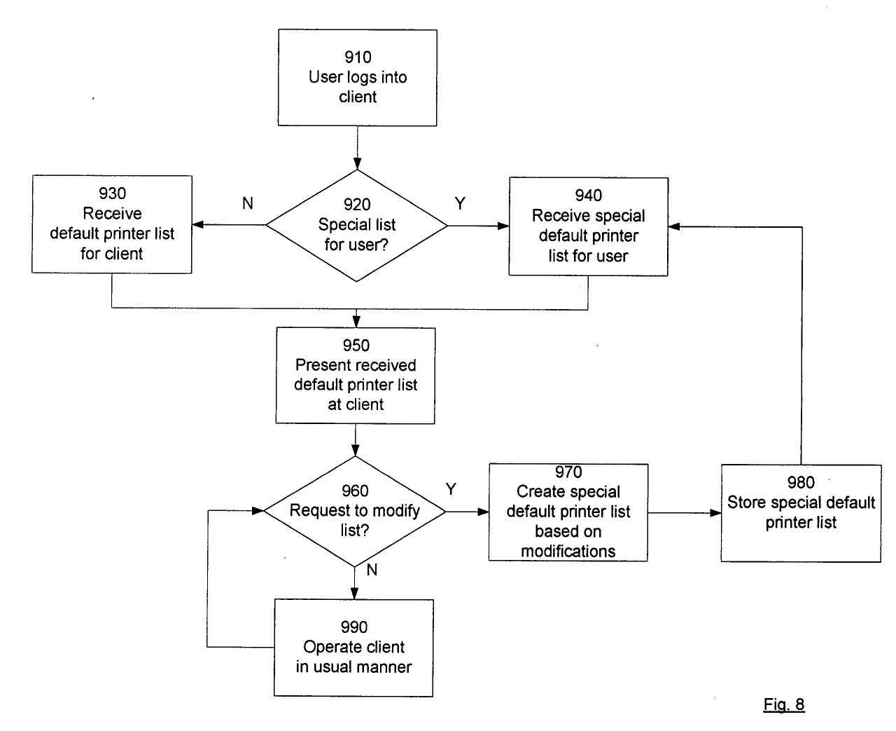

To help further explain variations to the foregoing embodiments, reference will now be made to FIG. 8 which shows a flowchart depicting a method indicated generally at 900. Beginning at step 910, a user (e.g. user U₁) logs into a client (e.g. client 38₁) in the usual manner. At step 920 a determination is made as to whether there is a special list of printers that are accessed by that particular user (i.e. user U₁) when that user is logged in to that particular client (i.e. client 38₁). In this example, no such list exists and so the method advances to step 930 in which a default printer list is retrieved. The list would be stored on server 34 or accessible to server 34, and thus would be retrieved by the client from server 34. Alternatively, in the case that server 34 hosts applications for the client, the list can be retrieved by the hosted application within the server 34. Such a default list can be, for example, a list of printers associated with a client, such as the contents of Table I that associate local printers according to geographic convenience. Thus, in this example, the default list would simply show printer 42₁ to user U₁ logged in at client 38₁. Next, at step 950, the default printer list would be presented on the client 38.

At step 960, a determination is made as to whether the user U wishes to modify the list. If no, then method 900 advances to step 990 and the client is operated in the usual manner. As part of such usual operation, the user U at that client 38 can thus print documents in the usual manner—and can make use of the printers on the default list retrieved at step 930. In this example, user U₁ would be making use of printer 42₁ from client 38₁.

If, however, at step 960 the user chose to modify the list of printers presented at step 950, then method 900 would advance to step 970 at which point the user accessing the particular client could modify the list presented at step 950 and thereby created a special printer list. Such a special list could include, adding printer 42₃ to the list of printers. (It could also including deleting or adding as many other printers in system 30 as desired.) Once such a list is created, it is then stored on server 34. Method 900 then advances to step 940, and the special printer list for user U at that particular client 38 is received. Method 900 then moves from step 940 to step 950 and the method continues in substantially the same fashion as previously described. Now, however, at step 950 and at step 990, user U₁ logged in at client 38₁ will be readily able to access printer U₁ and printer 42₃. By the same token, when user U₁ begins method 900 anew by logging back into client 38₁, method 900 will cycle to step 940 and retrieve the special list on the first pass through method 900.

It should now be apparent that method 900 can be varied. In other embodiments, the default printer list of step 930 is not a default printer list as accessed through Table I of local printers based on geographical convenience. In one embodiment, the default printer list received at step 930 is a list of printers defined for user U and/or a group that user U is a member. These user and/or group specific default lists could be stored on server 34 or another server or database accessible to server 34. In another embodiment, the default list received at step 930 is a combined list of printers including a list of printers associated with the client (for example the local printers based on geographical convenience) and a list of printers defined for user U and/or a group that user U is a member.

In a highly simplified embodiment, only steps 910, 930, 950 and 960 are present—and the user will have no option to create or use a special, personalized list of printers. Instead, only a default list of printers 42 for a particular client 38, a default list of printers 42 for a particular user U and/or a combined default list of printers 42 for a particular device 38 and a particular user U will be presented. While the user may be able to access ALL printers in the system 30 (or not, according to whether the default list is a security policy), only the default list will be presented at step 950.

As another variation of method 900, steps 920 and 930 are eliminated, such that there is only a special list of printers for a particular user U at a particular client 38.

Combinations and further variations of the foregoing will now occur to those of skill in the art.

It should be understood that server 34 can be implemented in a distributed manner, wherein method 200 is actually performed across a plurality of different computing devices that perform the same function as server 34. For example, steps 210-230 can be performed by one computing device, while step 240 is performed by another computing device. Expressed another way, policy P (or its variants) can be implemented and administered on one computing device, whereas the print routing can be implemented on another computing device.

The above-described embodiments of the invention are intended to be examples of the present invention and alterations and modifications may be effected thereto, by those of skill in the art, without departing from the scope of the invention which is defined solely by the claims appended hereto.

1. A networked computing apparatus comprising:
an interface coupled to a plurality of clients via at least one link; each of said clients operable to transmit a print request to a plurality of printers;
a data storage device for storing a data file comprising a record comprising at least one default printer identification respective to an indicia obtainable from one of said clients; each of said at least one default printer identification chosen to identify one of said printers; and
a processing unit coupled to said interface and said data storage device; said processing unit for receiving said indicia from one of said clients; said processing unit operable to retrieve said record using said received indicia; and said processing unit further operable to forward said at least one default printer identification to the one of said clients from which said indicia was received.

2. The networked computing apparatus of claim 1, wherein said indicia comprises a client identifier associated with the one of said clients.

3. The networked computing apparatus of claim 2, wherein said at least one default printer identification comprises at least one default printer identification corresponding to at least one printer physically proximate to the one of said clients.

4. The networked computing apparatus of claim 2, wherein said client identifier comprises one of a network address assigned to the one of said clients and a machine identifier associated with the one of said clients.

5. The networked computing apparatus of claim 2, wherein said indicia further comprises a user identifier associated with a user of the one of said clients.

6. The networked computing apparatus of claim 1, wherein said indicia comprises a user identifier associated with a user of the one of said clients.

7. The networked computing apparatus of claim 6, wherein said at least one default printer identification comprises at least one default printer identification corresponding to at least one printer associated with said user.

8. The networked computing apparatus of claim 6, wherein all of said at least one default printer identification correspond to printers in which said user is permitted to access based upon access rights of said user.

9. The networked computing apparatus of claim 6, wherein said user identifier comprises a group identifier associated with a group that said user is a member.

10. The networked computing apparatus of claim 9, wherein said at least one default printer identification comprises at least one default printer identification corresponding to at least one printer associated with said group that said user is a member.

11. The networked computing apparatus of claim 9, wherein said group comprises one or more members grouped by job title, job function, job level, organization, department, customer type, predefined physical location and customer account balance.

12. The networked computing apparatus of claim 6, wherein said processing unit is operable to receive input from said user of the one of said clients via the one of said clients, said input changing said at least one default printer identification in said record.

13. The networked computing apparatus of claim 1, wherein said interface, said processing unit and said data storage device are implemented in a distributed manner in two or more separate, networked computing devices.

14. The networked computing apparatus of claim 1, wherein said data storage device includes at least one of volatile storage and persistent storage.

15. The networked computing apparatus of claim 1, wherein said printers are coupled to said clients via said interface for routing print jobs from said clients through said processing unit.

16. The networked computing apparatus of claim 1, wherein said processing unit is operable to forward said at least one default printer identification to the one of said clients in a printer setting change message comprising said at least one default printer identification.

17. The networked computing apparatus of claim 1, wherein said processing unit is operable to receive a request for a print job from the one of said clients; and said processing unit is operable to forward said at least one default printer identification to the one of said clients in a print request response message comprising a printer selection option including said at least one default printer identification.

18. An application server apparatus incorporating the networked computing apparatus of claim 1, said application server apparatus operable to host at least one application for the one of said clients; wherein, to forward said at least one default printer identification to the one of said clients, said processing unit is operable to forward said at least one default printer identification to said application in a printer setting change message comprising said at least one default printer identification and said application is operable to forward said at least one default printer identification to the one of said clients in a print request response message in response to a print job request from the one of said clients, said print request response message comprising a printer selection option including said at least one default printer identification.

19. The application server apparatus of claim 18, wherein said application is further operable to receive a print request confirmation message comprising a selection of a printer in response to said printer selection option; and said application is further operable to generate a print job corresponding to said print job request and transmit said generated print job to said selected printer.

20. An application server apparatus incorporating the networked computing apparatus of claim 1, said application server apparatus operable to host at least one application for the one of said clients and said processing unit is operable to receive a request for a print job corresponding to said application from the one of said clients; wherein said processing unit is operable to forward said at least one default printer identification to the one of said clients in a print request response message comprising a printer selection option including said at least one default printer identification.

21. The application server apparatus of claim 20, wherein said processing unit is further operable to receive a print request confirmation message comprising a selection of a printer in response to said printer selection option; and said processing unit is further operable to generate a print job corresponding to said print job request and transmit said generated print job to said selected printer.

22. A networked computing apparatus comprising:
an interface coupled to a plurality of clients via at least one link; each of said clients operable to transmit a print request to a plurality of printers; and
a processing unit coupled to said interface and operable to access a data storage device; said processing unit for receiving an indicia from one of said clients; said processing unit operable to retrieve at least one default printer identification from said data storage device using said received indicia, said at least one default printer identification chosen to identify one of said printers; and said processing unit further operable to forward said at least one default printer identification to the one of said clients from which said indicia was received.

23. The networked computing apparatus of claim 22, wherein said indicia comprises a client identifier associated with the one of said clients.

24. The networked computing apparatus of claim 23, wherein said at least one default printer identification comprises at least one default printer identification corresponding to at least one printer physically proximate to the one of said clients.

25. The networked computing apparatus of claim 23, wherein said client identifier comprises one of a network address assigned to the one of said clients and a machine identifier associated with the one of said clients.

26. The networked computing apparatus of claim 23, wherein said indicia further comprises a user identifier associated with a user of the one of said clients.

27. The networked computing apparatus of claim 22, wherein said indicia comprises a user identifier associated with a user of the one of said clients.

28. The networked computing apparatus of claim 27, wherein said at least one default printer identification comprises at least one default printer identification corresponding to at least one printer associated with said user.

29. The networked computing apparatus of claim 27, wherein all of said at least one default printer identification correspond to printers in which said user is permitted to access based upon access rights of said user.

30. The networked computing apparatus of claim 27, wherein said user identifier comprises a group identifier associated with a group that said user is a member.

31. The networked computing apparatus of claim 30, wherein said at least one default printer identification comprises at least one default printer identification corresponding to at least one printer associated with said group that said user is a member.

32. The networked computing apparatus of claim 27, wherein said group comprises one or more members grouped by job title, job function, job level, organization, department, customer type, predefined physical location and customer account balance.

33. The networked computing apparatus of claim 27, wherein said processing unit is operable to receive input from said user of the one of said clients via the one of said clients, said input changing said at least one default printer identification.

34. The networked computing apparatus of claim 22, wherein said interface and said processing unit are implemented in a distributed manner in two or more separate, networked computing devices.

35. The networked computing apparatus of claim 22, wherein said printers are coupled to said clients via said interface for routing print jobs from said clients through said processing unit.

36. The networked computing apparatus of claim 22, wherein said processing unit is operable to forward said at least one default printer identification to the one of said clients in a printer setting change message comprising said at least one default printer identification.

37. The networked computing apparatus of claim 22, wherein said processing unit is operable to receive a request for a print job from the one of said clients; and said processing unit is operable to forward said at least one default printer identification to the one of said clients in a print request response message comprising a printer selection option including said at least one default printer identification.

38. An application server apparatus incorporating the networked computing apparatus of claim 22, said application server apparatus operable to host at least one application for the one of said clients; wherein, to forward said at least one default printer identification to the one of said clients, said processing unit is operable to forward said at least one default printer identification to said application in a printer setting change message comprising said at least one default printer identification and said application is operable to forward said at least one default printer identification to the one of said clients in a print request response message in response to a print job request from the one of said clients, said print request response message comprising a printer selection option including said at least one default printer identification.

39. The application server apparatus of claim 38, wherein said application is further operable to receive a print request confirmation message comprising a selection of a printer in response to said printer selection option; and said application is further operable to generate a print job corresponding to said print job request and transmit said generated print job to said selected printer.

40. An application server apparatus incorporating the networked computing apparatus of claim 22, said application server apparatus operable to host at least one application for the one of said clients and said processing unit is operable to receive a request for a print job corresponding to said application from the one of said clients; wherein said processing unit is operable to forward said at least one default printer identification to the one of said clients in a print request response message comprising a printer selection option including said at least one default printer identification.

41. The application server apparatus of claim 40, wherein said processing unit is further operable to receive a print request confirmation message comprising a selection of a printer in response to said printer selection option; and said processing unit is further operable to generate a print job corresponding to said print job request and transmit said generated print job to said selected printer.

42. A method comprising:
receiving an indicia from one of a plurality of clients, each of said clients operable to transmit a print request to a plurality of printers;
retrieving a data record comprising at least one default printer identification respective to said received indicia; each said at least one default printer identification chosen to identify one of said printers; and
forwarding said at least one default printer identification to the one of said clients from which said indicia was received.

43. The method of claim 42, wherein said indicia comprises a client identifier associated with the one of said clients.

44. The method of claim 43, wherein said at least one default printer identification comprises at least one default printer identification corresponding to at least one printer physically proximate to the one of said clients.

45. The method of claim 43, wherein said client identifier comprises one of a network address assigned to the one of said clients and a machine identifier associated with the one of said clients.

46. The method of claim 43, wherein said indicia further comprises a user identifier associated with a user of the one of said clients.

47. The method of claim 42, wherein said indicia comprises a user identifier associated with a user of the one of said clients.

48. The method of claim 47, wherein said at least one default printer identification comprises at least one default printer identification corresponding to at least one printer associated with said user.

49. The method of claim 47, wherein all of said at least one default printer identification correspond to printers in which said user is permitted to access based upon access rights of said user.

50. The method of claim 47, wherein said user identifier comprises a group identifier associated with a group that said user is a member.

51. The method of claim 50, wherein said at least one default printer identification comprises at least one default printer identification corresponding to at least one printer associated with said group that said user is a member.

52. The method of claim 50, wherein said group comprises one or more members grouped by job title, job function, job level, organization, department, customer type, predefined physical location and customer account balance.

53. The method of claim 47 further comprising receiving input from said user of the one of said clients via the one of said clients, said input changing said at least one default printer identification in said record.

54. The method of claim 42, wherein said forwarding step comprises forwarding said at least one default printer identification to the one of said clients in a printer setting change message comprising said at least one default printer identification.

55. The method of claim 42 further comprising receiving a request for a print job from the one of said clients; and wherein said forwarding step comprises forwarding said at least one default printer identification to the one of said clients in a print request response message comprising a printer selection option including said at least one default printer identification.

56. The method of claim 42 further comprising hosting at least one application for the one of said clients; wherein said forwarding step comprises forwarding said at least one default printer identification to said application in a printer setting change message comprising said at least one default printer identification and forwarding said at least one default printer identification to the one of said clients in a print request response message in response to a print job request from the one of said clients, said print request response message comprising a printer selection option including said at least one default printer identification.

57. The method of claim 56 further comprising receiving a print request confirmation message comprising a selection of a printer in response to said printer selection option, generating a print job corresponding to said print job request and transmitting said generated print job to said selected printer.

58. The method of claim 42 further comprising hosting at least one application for the one of said clients and receiving a request for a print job corresponding to said application from the one of said clients; wherein said forwarding step comprises forwarding said at least one default printer identification to the one of said clients in a print request response message comprising a printer selection option including said at least one default printer identification.

59. The method of claim 58 further comprising receiving a print request confirmation message comprising a selection of a printer in response to said printer selection option, generating a print job corresponding to said print job request and transmitting said generated print job to said selected printer.

60. A computer readable medium storing logic adapted to implement a method for printer management, the method comprising: receiving an indicia from one of a plurality of clients, each of said clients operable to transmit a print request to a plurality of printers; retrieving a data record comprising at least one default printer identification respective to said received indicia; each said at least one default printer identification chosen to identify one of said printers; and forwarding said at least one default printer identification to the one of said clients from which said indicia was received.

61. A server comprising:
an interface connected to a plurality of clients via at least one link; each of said clients operable to transmit a print request to a plurality of printers;
a data storage device for storing a data file comprising a record comprising at least one default printer identification respective to a user identification; each said at least one default printer identification chosen to identify one of said printers; and,
a processing unit coupled to said interface and said data storage device; said processing unit for receiving an identity of said user from one of said clients; said processing unit operable to retrieve said record by matching said identity to said user identification; said processing unit further operable to forward said at least one default printer identification to the one of said clients from which said identity was received.

62. The server of claim 61 wherein said processing unit is operable to receive input from said user via said at least one client that changes said at least one default printer identification in said record.

63. The server of claim 61 wherein said at least one default printer identification is chosen according to which one of said clients said user is accessing.

64. The server of claim 63 wherein said at least one default printer identification is chosen based on which of said printers is closest to the one of said clients from which said identity was received.

65. The server of claim 61 wherein said at least one default printer identification is chosen based on access rights that exclusively indicate which of said at least one printers each said user is permitted to access.

66. The server of claim 61 wherein said at least one default printer identification is chosen based on an indicator having an association with each one of said printers.

67. The server of claim 66 wherein said indicator is an identity of each of said clients and said association is based on which one of said printers is geographically closest to each of said clients.

68. The server of claim 66 wherein said indicator is a job description for each of said users and said association is based on a correspondence between said job description and a type of each of said printers.

69. The server of claim 61 wherein at least two of said interface, said processor and said data storage device are implemented in a distributed manner across a plurality of separate, networked computing devices.

70. The server of claim 61 wherein said data storage device includes at least one of volatile storage and persistent storage.

71. The server of claim 61 wherein said printers are connected to said clients via said interface for routing print jobs from said clients through said processor.

72. A method comprising:
receiving a user identity from one of a plurality of clients that are connected to a plurality of printers;
retrieving a data record comprising at least one default printer identification respective to said user identity; each said at least one default printer identification chosen to identify one of said printers; and,
forwarding said at least one default printer identification to the one of said clients from which said identity was received.

73. A computer readable medium storing a data file comprising at least one record comprising at least one default printer identification respective to an identity of a user; each said at least one default printer identification chosen to identify one of a plurality of printers that are connectable to a plurality of clients accessible to said user.

74. A method comprising:
sending a user identity from one of a plurality of clients that are connected to a plurality of printers;
receiving at least one default printer identification respective to said user identity; each said at least one default printer identification chosen to identify one of said printers.
